(19) United States
(12) Patent Application Publication
(10) Pub. No.: US 2007/0229498 A1
(43) Pub. Date: Oct. 4, 2007

(54) Statistical modeling for synthesis of detailed facial geometry

(76) Inventors: Wojciech Matusik, Cambridge, MA (US); Hanspeter Pfister, Arlington, MA (US); Aleksey Golovinsky, Princeton, NJ (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/392,917

(22) Filed: Mar. 29, 2006

(51) Int. Cl. G06T 17/00

(52) U.S. Cl. 345/420; 382/154

(57) ABSTRACT

The invention provides a system and method for modeling small three-dimensional facial features, such as wrinkles and pores. A scan of a face is acquired. A polygon mesh is constructed from the scan. The polygon mesh is reparameterized to determine a base mesh and a displacement image. The displacement image is partitioned into a plurality of tiles. Statistics for each tile are measured. The statistics is modified to deform the displacement image and the deformed displacement image is combined with the base mesh to synthesize a novel face.

### FIELD OF THE INVENTION

This invention relates generally to computer graphics and modeling human faces, and more particularly to modeling fine facial features such as wrinkles and pores.

### BACKGROUND OF THE INVENTION

Generating realistic models of human faces is an important problem in computer graphics. Face models are widely used in computer games, commercials, movies,. and for avatars in virtual reality applications. The goal is to capture all aspects of a face in a digital model, see Pighin et al., “Digital face cloning,” SIGGRAPH 2005 Course Notes, 2005.

Ideally, an image generated from a face model should be indistinguishable from an image of a real face. However, digital face cloning remains a difficult task for several reasons. First, humans can easily spot artifacts in computer generated models. Second, capturing the high resolution geometry of a face is difficult and expensive. Third, editing face models is still a time consuming and largely manual task, especially when changes to fine-scale details are required.

It is particularly difficult to model small facial features, such as wrinkles and pores. Wrinkles are folds of skin formed through the process of skin deformation, whereas pores are widely dilated orifices of glands that appear on the surface of skin, Igarashi et al., “The appearance of human skin,” Tech. Rep. CUCS-024-05, Department of Computer Science, Columbia University, June 2005.

Acquiring high-resolution face geometry with small features is a difficult, expensive, and time-consuming task. Commercial active or passive photometric stereo systems only capture large wrinkles and none of the important small geometric details, such as pores that make skin look realistic.

Laser scanning systems may be able to capture the details, but they are expensive and require the subject to sit still for tens of seconds, which is impractical for many applications. Moreover, the resulting 3D geometry has to be filtered and smoothed due to noise and motion artifacts. The most accurate method is to make a plaster mold of a face and to scan this mold using a precise laser range system. However, not everybody can afford the considerable time and expense this process requires. In addition, the molding compound may lead to sagging of facial features.

Numerous methods are known for modeling faces in computer graphics and computer vision.

Morphable Face Models:

One method uses variational techniques to synthesize faces, DeCarlo et al., “An anthropometric face model using variational techniques,” SIGGRAPH 1998: Proceedings, pp. 67-74, 1998. Because of the sparseness of the measured data compared to the high dimensionality of possible faces, the synthesized faces are not as plausible as those produced using a database of scans.

Another method uses principal component analysis (PCA) to generate a morphable face model from a database of face scans, Blanz et al., “A morphable model for the synthesis of 3D faces,” SIGGRAPH 1999: Proceedings, pp. 187-194, 1999. That method was extended to multi-linear face models, Vlasic et al., “Face transfer with multi-linear models,” ACM Trans. Graph. 24, 3, pp. 426-433, 2005. Morphable models have also been used in 3D face reconstruction from photographs or video.

However, current linear or locally-linear morphable models cannot be, directly applied to analyzing and synthesizing high-resolution face models. The dimensionality, i.e., a length of the eigenvector, of high-resolution face models is very large, and an unreasonable amount of data is required to capture small facial details. In addition, during construction of the model, it would be difficult or impossible to find exact correspondences between high resolution details of all the input faces. Without correct correspondence, the weighted linear blending performed by those methods would blend small facial features, making the result implausibly smooth in appearance.

Physical/Geometric Wrinkle Modeling:

Other methods directly model the physics of skin folding, Wu et al., “A dynamic wrinkle model in facial animation and skin ageing,” Journal of Visualization and Computer Animation, 6, 4, pp. 195-206, 1995; and Wu et al., “Physically-based wrinkle simulation & skin rendering,” Computer Animation and Simulation '97, Eurographics, pp. 69-79, 1997. However, those models are not easy to control, and do not produce results that can match high resolution scans in plausibility.

Wrinkles can also be modeled, Bando et al., “A simple method for modeling wrinkles on human skin,” Pacific Conference on Computer Graphics and Applications, pp. 166-175, 2002; and Larboulette et al., “Real-time dynamic wrinkles,” Computer Graphics International, IEEE Computer Society Press, 2004. Such methods generally proceed by having the user draw a wrinkle field and select a modulating function. The wrinkle depth is then modulated as the base mesh deforms to conserve length. This allows user control, and is well-suited for long, deep wrinkles, e.g. across the forehead. However, it is difficult for the user to generate realistic sets of wrinkles, and these methods do not accommodate pores and other fine scale skin features.

Texture Synthesis

The two main classes of texture synthesis methods are Markovian and parametric texture synthesis.

Markovian texture synthesis methods treat the texture image as a Markov random field. An image is constructed patch by patch, or pixel by pixel, by searching a sample texture for a region whose neighborhood matches the neighborhood of the patch or pixel to be synthesized. That method was extended for a number of applications, including a super-resolution filter, which generates a high resolution image from a low resolution image using a sample pair of low and high resolution images, Hertzmann et al., “Image analogies,” SIGGRAPH '01: Proceedings, pp. 327-340, 2001. Markovian methods have also been used for generation of facial geometry to grow fine-scale normal maps from small-sized samples taken at different areas of the face.

Parametric methods extract a set of statistics from sample texture. Synthesis starts with a noise image, and coerces it to match the statistics. The original method was described by Heeger et al., “Pyramid-based texture analysis/synthesis,” SIGGRAPH '95: Proceedings, pp. 229-238, 1995, incorporated herein by reference. The selected statistics were histograms of a steerable pyramid of the image. A larger and more complex set of statistics can be used to generate a greater variety of textures, Portilla et al., “A parametric texture model based on joint statistics of complex wavelet coefficients,” Int. Journal of Computer Vision 40, 1, pp. 49-70, 2000.

### SUMMARY OF THE INVENTION

Detailed surface geometry contributes greatly to visual realism of 3D face models. However, acquiring high-resolution face models is often tedious and expensive. Consequently, most face models used in games, virtual reality simulations, or computer vision applications look unrealistically smooth.

The embodiments of the invention provide a method for modeling small three-dimensional facial features, such as wrinkles and pores. To acquire high-resolution face geometry, faces across a wide range of ages, genders, and races are scanned.

For each scan, the skin surface details are separated from a smooth base mesh using displaced subdivision surfaces. Then, the resulting displacement maps are analyzed using a texture analysis and synthesis framework, adapted to capture statistics that vary spatially across a face. The extracted statistics can be used to synthesize plausible detail on face meshes of arbitrary subjects.

The method is effective for a number several applications, including analysis of facial texture in subjects with different ages and genders, interpolation between high resolution face scans, adding detail to low-resolution face scans, and adjusting the apparent age of faces. The method is able to reproduce fine geometric details consistent with those observed in high resolution scans.

### BRIEF DESCRIPTION OF THE DRAWINGS

FIG. 1 is a high level block diagram of a method for analyzing, modeling, and synthesizing faces according to an embodiment of the invention;

FIG. 2 is a detailed block diagram of a method for analyzing, modeling, and synthesizing faces according to an embodiment of the invention;

FIG. 3 shows a displacement image partitioned into tiles according to an embodiment of the invention;

FIG. 4 shows histograms and filter output according to an embodiment of the invention;

FIG. 5 shows a visualization for a second scale of a pyramid with expanded circles according to an embodiment of the invention;

FIG. 6 shows aging according to an embodiment of the invention; and

FIG. 7 shows de-aging according to an embodiment of the invention.

### DETAILED DESCRIPTION OF THE PREFERRED EMBODIMENTS

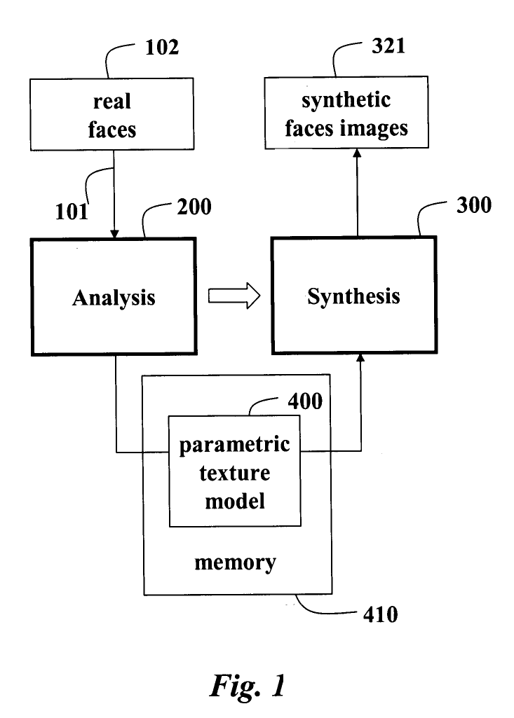

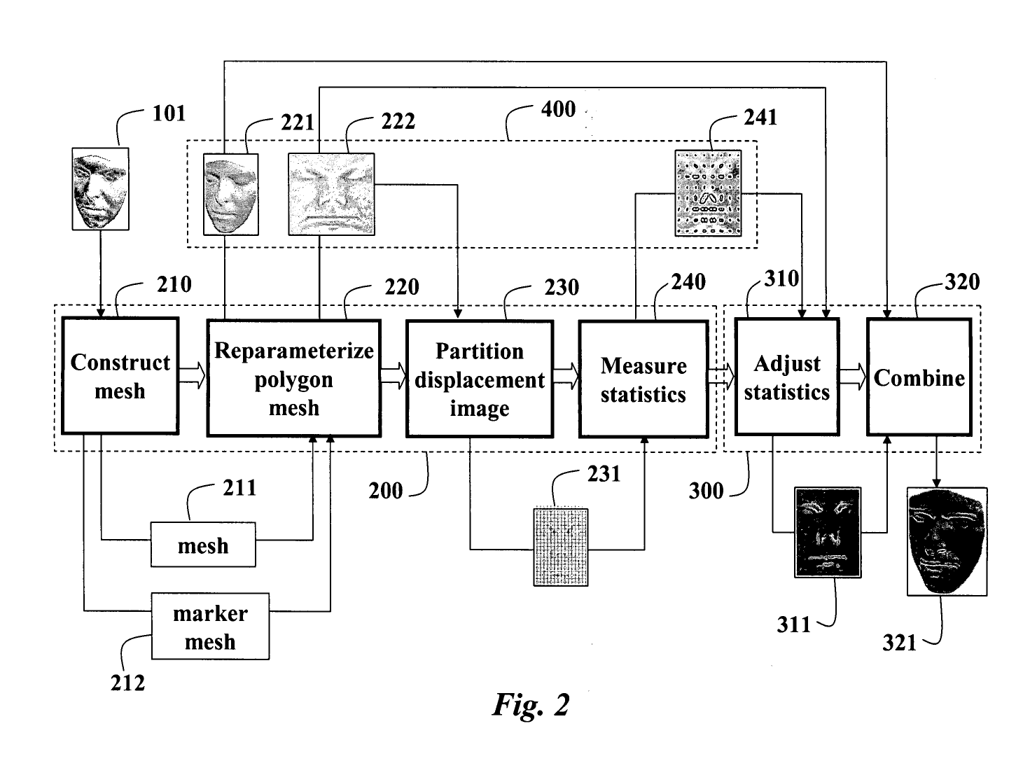

As shown in FIGS. 1 and 2, our invention provides a method for analyzing, modeling and synthesizing fine details in human faces. Input to the method are a large number of scans 101 of real faces 102. The scans include three-dimensional geometry of the faces, and texture in the form of images. The real faces 102 include age, gender, and race variations. Each scan 101 is analyzed 200 to construct a parametric texture model 400. The model can be stored in a memory 410. The model can then later be used to synthesize 300 images 321 of synthetic faces. The analysis only needs to be performed once for each face scan. The synthesis can be performed any number of times and for different applications.

Analysis 200 begins with a high-resolution scan 101 of each real face to construct 210 a polygon mesh 211 having, e.g.,

500,000 triangles. The mesh is reparameterized 220 and separated into a base mesh 221 and a displacement image 222. The displacement image 222 is partitioned 230 into tiles 231. Statistics 241 are measured 240 for each tile.

The synthesis 300 modifies the statistics 241 to adjust 310 the displacement image 222. The adjusted displacement image 311 is then combined 320 with the base mesh 221 to form a synthetic face image 321.

Data Acquisition

We acquire high resolution face scans for a number of subjects with variations in age, gender and race. Each subject sits in a chair with a head rest to keep the head still during data acquisition. We acquire the complete three-dimensional face geometry using a commercial face-scanner. The output mesh contains 40 k vertices and is manually cropped and cleaned. Then, we refine the mesh to about 700 k vertices using loop subdivision. The resulting mesh is too smooth to resolve fine facial details.

The subject is also placed in a geodesic dome with multiple cameras and LEDs, see U.S. patent application Ser. No. 11/092,426, “Skin Reflectance Model for Representing and Rendering Faces,” filed on Mar. 29, 2005 by Weyrich et al., and incorporated herein by reference. The system sequentially turns on each LED while simultaneously capturing images from different viewpoints with sixteen cameras. The images capture the texture of the face. Using the image data, we refine the mesh geometry and determine a high-resolution normal map using photometric stereo processing. We combine the high-resolution normals with the low-resolution geometry, accounting for any bias in the normal field. The result is the high-resolution (500 k polygons) face mesh 211 with approximately 0.5 mm sample spacing and low noise, e.g., less than 0.05 mm, which accurately captures fine geometric details, such as wrinkles and pores.

Reparametrization

For the reparamertization, we determine vertex correspondence between output meshes from the face scanner. We manually define a number of feature points in an image of a face, e.g. , twenty-one feature points. With pre-defined connectivity, the feature points form a “marker” mesh 212, by which all of the faces are rigidly aligned. The marker mesh 212 is subdivided and re-projected in the direction of the normals onto the original face scan several times, yielding successively more accurate approximations of the original scan. Because the face meshes are smooth relative to the marker mesh, self-intersections do occur.

A subtle issue is selecting the correct subdivision strategy. If we use an interpolating subdivision scheme, marker vertices remain in place and the resulting meshes have relatively accurate per vertex correspondences. However, butterfly subdivision tends to pinch the mesh, and linear subdivision produces a parameterization that has discontinuities in its derivative. An approximating method, such as Loop subdivision, produces smoother parameterization at the cost of moving vertices and making the correspondences worse, Loop, “Smooth Subdivision Surfaces Based on Triangles,” Master's thesis, University of Utah, 1987, incorporated herein by reference. The selection of subdivision scheme offers the tradeoff between a smooth parameterization and better correspondences.

Because the first several rounds of subdivision would move vertices the furthest under approximating schemes, we use two linear subdivisions followed by two Loop subdivisions. This gives us the mesh 211 from which we determine the scalar displacement image 222 that captures the remaining face detail, see Lee et al., “Displaced subdivision surfaces,” SIGGRAPH '00: Proceedings, pp. 85-94, 2000, incorporated herein by reference.

Specifically, we subdivide the mesh 211 three times with Loop subdivision. This gives us a coarse, smooth mesh we refer to as the base mesh 221. We project the base mesh onto the original face, and define the displacement image by the length of this projection at each vertex. To map this to an image, we start with the marker mesh 212 mapped in a pre-defined manner to a rectangle, and follow the sequence of subdivisions in the rectangle.

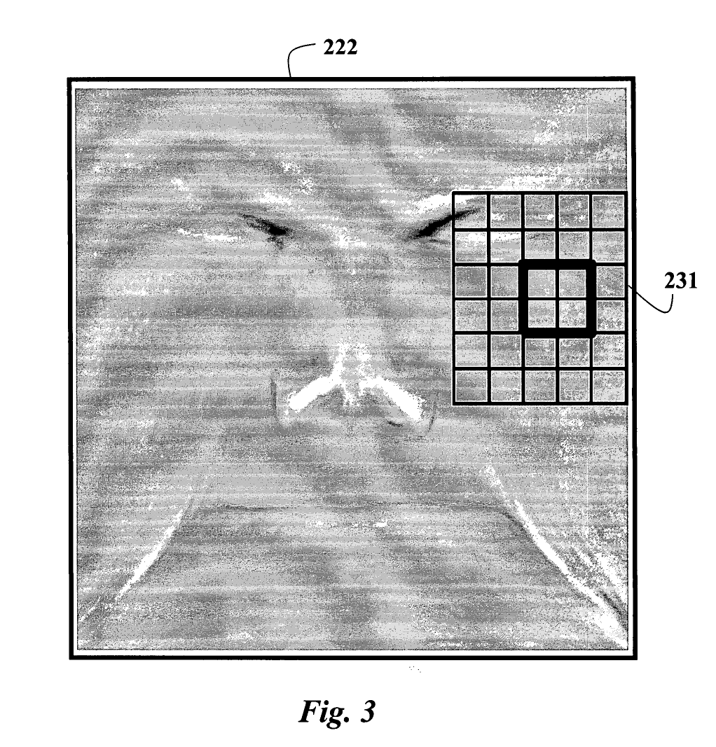

We represent the displacement images with 1024×1024 samples, i.e., pixel intensities. The displacement images essentially capture the texture of the face. One partitioned displacement image 222 is shown in FIG. 3.

Extraction of Statistics

We measure 240 the fine detail in the facial displacement image to obtain statistics. Our goal is to represent the displacements with enough accuracy to retain wrinkles and pores in a compact model suitable for synthesis 300 of details on new faces.

Our statistics method is an extension of texture synthesis techniques commonly used for images. Following Heeger et al., we extract histograms of steerable pyramids of a sample texture in the images to capture the range of content the texture has at several scales and orientations, see Simoncelli et al., “The steerable pyramid: a flexible architecture for multi-scale derivative computation,” ICIP '95: Proceedings, International Conference on Image Processing, vol. 3, 1995, incorporated herein by reference. Direct application of conventional methods would define a set of global statistics for each face, which are not immediately useful because the statistics of facial detail vary spatially. We make the modification of taking statistics of image tiles 231 to capture the spatial variation. Specifically, we decompose the images into 256 tiles in a 16×16 grid and construct the steerable pyramids with 4 scales and 4 orientations for each tile. We consider the high-pass residue of the texture, but not the low pass residue of the texture, which we take to be part of the base mesh. This makes for seventeen filter outputs.

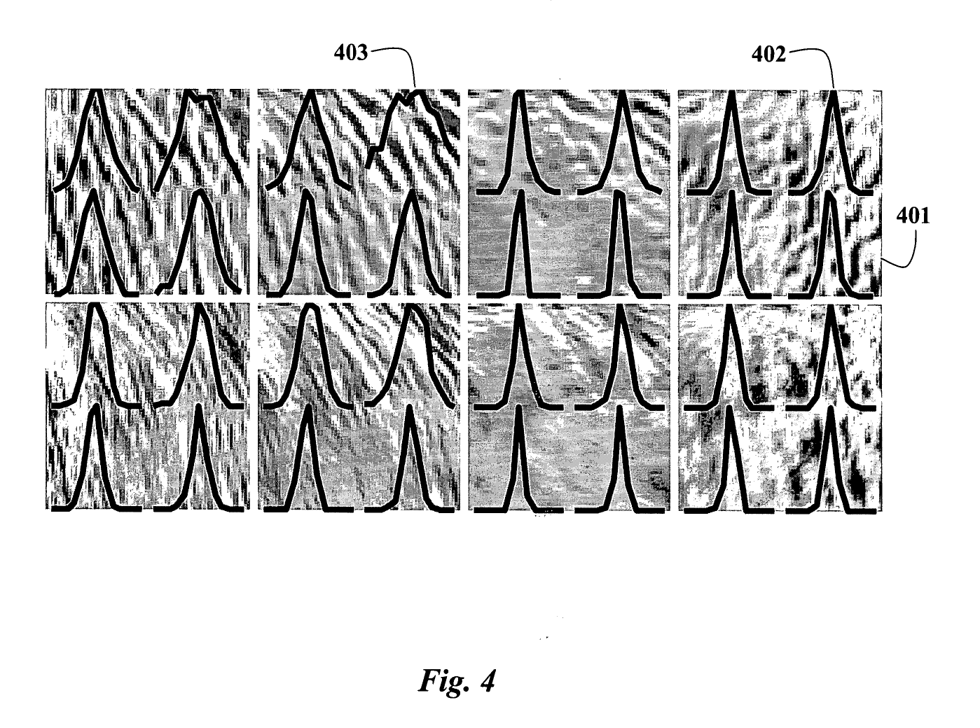

FIG. 4 shows histograms 401 and filter outputs for two scales for 2×2 sections of tiles. The filter responses and histograms of the outlined 2×2 section are shown. All orientations and two scales are shown. Tiles with more content have wider histograms 403 than the histograms 402 for tiles with less content.

Storing, analyzing, interpolating, and rendering these histograms is cumbersome, because the histograms contain a lot of data. However, we observe that the main difference between the histograms in the same tile for different faces is their width. So, we approximate each histogram by its standard deviation. This allows significant compression of the data. The statistics of a face contain a scalar for each tile in each filter response: 17×16×16=4,352 scalars, compared with 128×17×16×16=557,056 scalars in the histograms if we use 128 bins, and 1024×1024=1,048,576 scalars in the original image. The faces synthesized from these reduced statistics are visually indistinguishable from those synthesized with the full set of histograms.

This reduced set of statistics is not only reduces storage and processing time, but also allows for easier visualization and a better understanding of how the statistics vary across a face and across populations of faces. For example, for each scale and tile, we can draw the standard deviations for all filter directions as a circle expanded in each direction by the standard deviation computed for that direction.

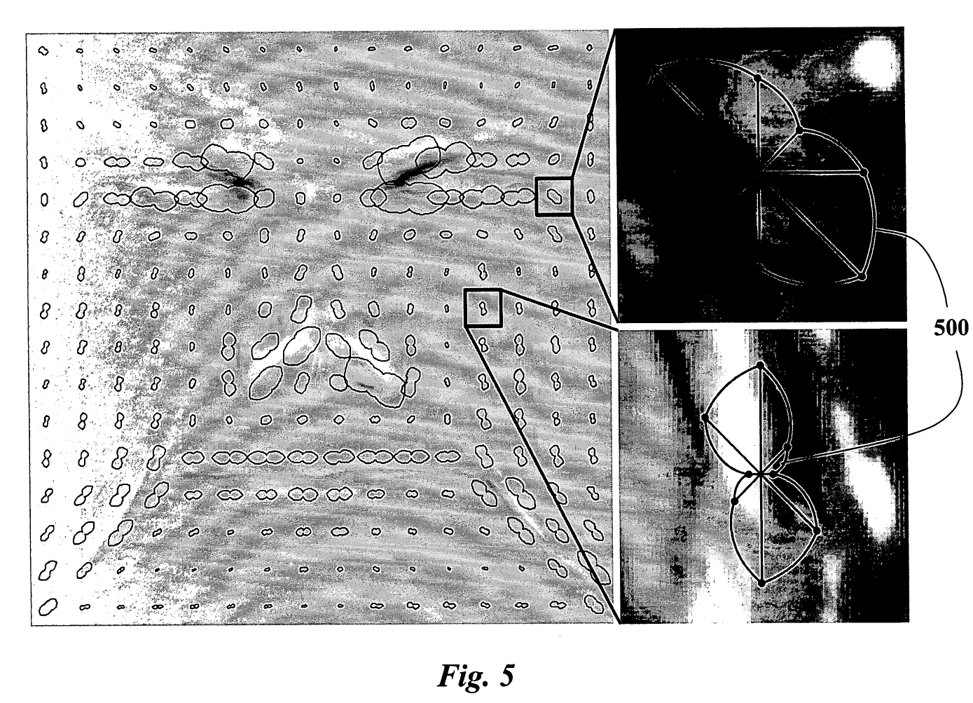

FIG. 5 shows such a visualization for the second scale of the pyramid (512×512 pixels) with expanded circles 500.

Synthesis

The statistics are used to synthesize facial detail. Heeger et al., accomplishes this as follows. The sample texture is expanded into its steerable pyramid. The texture to be synthesized is started with noise, and is also expanded. Then, the histograms of each filter of the synthesized texture are matched to those of the sample texture, and the pyramid of the synthesized texture is collapsed, and expanded again. Because the steerable pyramid forms an over-complete basis, collapsing and expanding the pyramid changes the filter outputs if the outputs are adjusted independently. However, repeating the procedure for several iterations leads to convergence.

The prior art process needs to be modified to use our reduced set of spatially varying statistics. The histogram-matching step is replaced with matching standard deviations. In this step, a particular pixel will have its four neighboring tiles suggest four different values. We interpolate bilinearly between these four values. Then, we proceed as above, collapsing the pyramids, expanding, and repeating iteratively.

Adjusting standard deviation in this manner by bilinear interpolation does not end with the synthesized tiles having the same deviation as the target tiles. However, if this step is repeated several times, the deviation of the synthesized tiles converges to the desired deviation. In practice, doing this matching iteratively results in a mesh visually indistinguishable from a mesh synthesized with only one matching step per iteration.

Conventional parametric texture synthesis usually begins with a noise image. Instead, for most of our applications, we begin synthesis with the displacement image 222. In this case, iterative matching of statistics does not add new detail, but modifies existing detail with properly oriented and scaled sharpening and blurring.

If the starting image has insufficient detail, we add noise to the start image. We use white noise, and our experiences suggest that similarly simple noise models, e.g., Perlin noise, lead to the same results, see Perlin, “An image synthesizer,” SIGGRAPH '85: Proceedings, pp. 287-296, 1985. We are careful to add enough noise to cover possible scanner noise and meshing artifacts, but not so much that the amount of noise overwhelms existing detail.

Applications

Our statistical model of detailed face geometry is useful for a range of applications. The statistics enable analysis of facial detail, for example, to track changes in between groups of faces. The statistics also enable synthesis of new faces for applications such as sharpness preserving interpolation, adding detail to a low resolution mesh, and aging.

Analysis of Facial Detail

As a first application, we consider analysis and visualization of facial details. We wish to gain insight into how facial detail changes with personal characteristics. Or, we wish to use the statistics to classify faces based on the statistics of scans. To visualize the differences between groups, we normalize the statistics of each group to the group with the smallest amount of content, and compare the mean statistics on a tile-by-tile basis. For instance, we can use this approach to study the effects of age and gender.

Age

To study the effect of age, we compare three groups of males aged 20-30, 35-45, 50-60. Our statistics suggest that wrinkles develop more from the second age group to the third than from the first to the second. This suggests that after the age of 45 or so, the amount of roughness on skin increases more rapidly. After age 45, more directional permanent wrinkles develop around the comers of the eye, the mouth, and some areas on the cheeks and forehead.

Gender

To investigate how facial detail changes with gender, we compare 20-30 year-old women to males of the same age group. The change of high frequency content from females to males is different in character from that the change between varying age groups. Males have more high frequency content, but the change, for this age group, is relatively uniform and not as directional. In addition, males have much more content around the chin and lower cheeks. Although none of the scanned subjects had facial hair, this is likely indicative of stubble and hair pores on the male subjects.

Interpolation

There are a number applications in which it may be useful to interpolate between faces. A user interface for synthesizing new faces, for example, may present the user with faces from a data set, define a set of weights, and return a face interpolated from the input faces with the given weights. Alternatively, linear models can synthesize a face as a weighted sum of a large number of input faces.

Adding Detail

Low-resolution meshes can be produced from a variety of sources. Such a mesh can come from a commercial scanner, can be generated manually, or can be synthesized using a linear model from a set of input meshes. On the other hand, high resolution meshes are difficult and expensive to obtain. It would be useful to be able to add plausible high-resolution detail to a low-resolution face without having to obtain high-resolution meshes.

Alternatively, it may be convenient to adjust the low-resolution mesh to the mean statistics of an age group. Our framework allows the synthesis of detail on top of a low resolution mesh in a straightforward manner. We start with the displacement image of the low-resolution mesh, adjust it to match target statistics, and add it back to the base mesh. This process inherently adjusts to and takes advantage of the available level of detail in the starting mesh, so a more accurate starting mesh will result in a more faithful synthesized face.

Aging and De-aging

It may be desirable to change the perceived age of a face mesh. For example, we may want to make an actor look older or younger. The goal is to generate a plausible older version of a young face, and vice versa. Because facial detail plays such a key role in our perception of age, and because scans for the same individual taken at different ages are not available, changing age is a challenging task.

A simple approach copies high frequency content from an old person onto a young person. This overwrites the existing details of the starting mesh, and also creates ghosting in areas where the high frequency content of the old face does not align with the low frequency content of the young face. The model of Blanz et al. performs aging by linear regression on the age of the meshes in the set. However, this suffers the same problem as interpolation: wrinkles will not line up, and detail will be blurred. It also does not solve the problem of ghosting and disregards existing detail.

A key advantage of our method is that it starts with existing detail and adjusts the details appropriately. We describe our method of aging in more detail below; de-aging is done in the same manner.

Aging falls neatly into our synthesis framework. We select a young face and an old face. To age, we start with the image of the young face, and coerce it to match statistics of the old face. The resulting image contains the detail of the young face, with wrinkles and pores sharpened and elongated to adjust to the statistics of the old face.

To make the adjustment convincing, we change the underlying coarse facial structure. Our hierarchical decomposition of face meshes suggests a way to make such deformations. Prior to the displacement map, our remeshing scheme decomposes each face into a marker mesh and four levels of detail. In this case, we can take the marker mesh and lower levels of details from the young mesh, because these coarse characteristics are individual and do not change with age, and the higher levels of details from the old mesh.

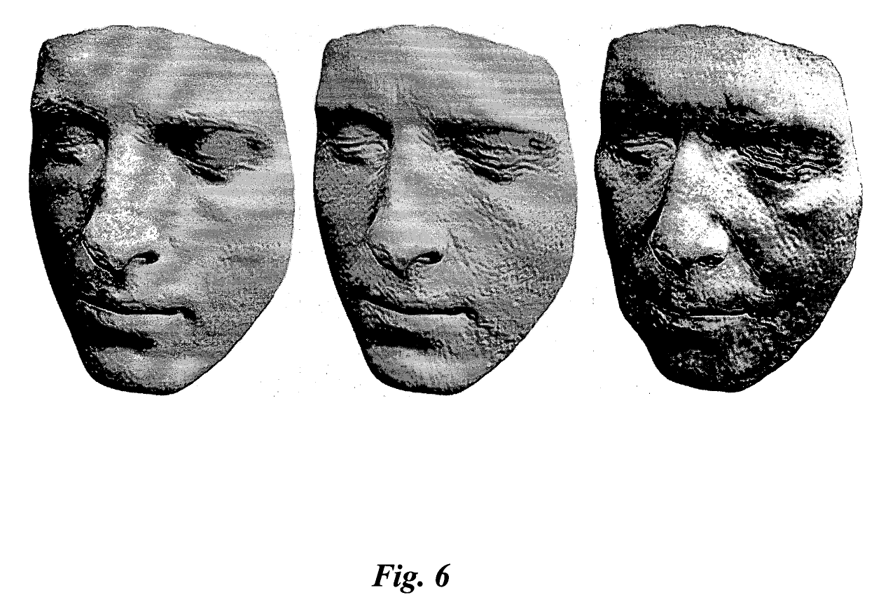

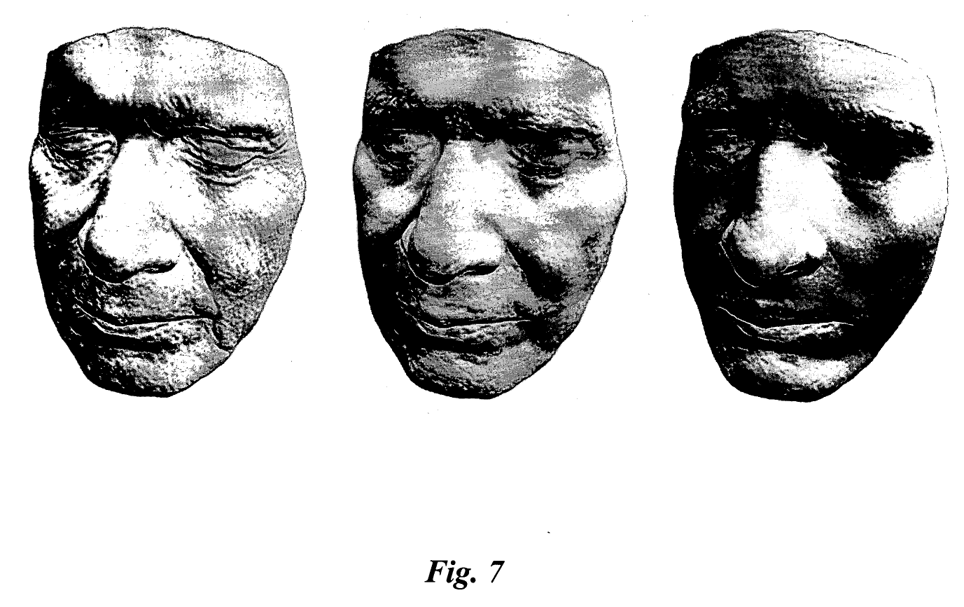

FIG. 6 shows aging, and FIG. 7 shows deaging. Near comers of the eyes and the forehead, the young face is adjusted to have the highly directional wrinkles of the old face. The young face also acquires the creases below the sides of the mouth. The deaged face has its wrinkles smoothed, for example, on the cheek, but retains sharpness in the creases of the mouth and eyelids.

### EFFECT OF THE INVENTION

We describe a method for analyzing and synthesizing facial geometry by separating faces into coarse base meshes and detailed displacement images, extracting the statistics of the detail images, and then synthesizing new faces with fine details based on extracted statistics.

The method provides a statistical model of fine geometric facial features based on an analysis of high-resolution face scans, an extension of parametric texture analysis and synthesis methods to spatially-varying geometric detail, a database of detailed face statistics for a sample population that will be made available to the research community, new applications, including introducing plausible detail to low resolution face models and adjusting face scans according to age and gender, and a parametric model that provides statistics that can be analyzed. We can perform analysis, compare the statistics of groups, and gain some understanding of the detail we are synthesizing. This also allows for easier and more direct statistics.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for generating a model of a face, comprising the steps of:
acquiring a scan of a face;
constructing a polygon mesh from the scan;
reparameterizing the polygon mesh to determine a base mesh and a displacement image;
partitioning the displacement image into a plurality of tiles;
measuring statistics for each tile;
storing the base mesh, the displacement image, and the statistics in a memory to generate a model of the face.

2. The method of claim 1, further comprising:
modifying the statistics to deform the displacement image; and
combining the deformed displacement image with the base mesh to synthesize a novel face.

3. The method of claim 1, in which the scan includes three-dimensional geometry of the face and images of textures of the face.

4. The method of claim 3, in which the reparameterization further comprises:
determining correspondences between vertices of the polygon mesh and feature points defined in the images.

5. The method of claim 4, in which the feature points form a marker mesh.

6. The method of claim 3, in which the measuring further comprises:
extracting histograms of steerable pyramids of the texture in each tile.

7. The method of claim 6, in which the steerable pyramids have a plurality of scales and a plurality of orientations.

8. The method of claim 6, in which the steerable pyramids consider high-pass residues of the texture, and low pass residues of the texture are part of the base mesh.

9. The method of claim 6, further comprising:
approximating each histogram with a standard deviation.

10. The method of claim 1, further comprising:
generating the model for a plurality of faces, in which the pluratity of faces include variations in age, gender and race.

11. The method of claim 10, further comprising:
classifying the plurality of faces according to the corresponding statistics.

12. The method of claim 1, further comprising:
aging the model.

13. The method of claim 1, further comprising:
de-aging the model.

14. A system for generating a model of a face, comprising the steps of:
means for acquiring a scan of a face;
means for constructing a polygon mesh from the scan;
means for reparameterizing the polygon mesh to determine a base mesh and a displacement image;
means for partitioning the displacement image into a plurality of tiles;
means for measuring statistics for each tile;
storing the base mesh, the displacement image and the statistics in a memory to generate a model of the face.
